(19) United States
(12) Patent Application Publication
(10) Pub. No.: US 2008/0145747 A1
(43) Pub. Date: Jun. 19, 2008

(54) Safety Structure for a Plastic Battery Case

(76) Inventor: Donald P.H. Wu, Hsinchu County (TW)

Correspondence Address: Dr. BANGER SHIA, 102 Lindencrest Ct., Sugar Land, TX, 77479-5201, US

(21) Appl. No.: 11/611,841

(22) Filed: Dec. 15, 2006

(51) Int. Cl. H01M 2/12

(52) U.S. Cl. 429/56

(57) ABSTRACT

A safety structure for a plastic battery case is disclosed, of which the battery case is a plastic unitary structure. On the inner surface of the receiving space of the battery case is formed at least one groove whose open side faces the interior of the battery case, so as to facilitate the collection of pressure, and in the bottom of the groove is formed a working portion which is the thinnest portion of the battery case, when internal pressure of the battery case exceeds a predetermined value, the closest grooves will bulge instantly, and the bulged working portion will not be ruptured right away. The working portion of the groove will bulge outward and become thinner and consequently form a slit to release the pressure safely.

### BACKGROUND OF THE INVENTION

1. Field of the Invention

The present invention relates to a safety structure for a plastic battery case, and more particularly to a safety design for a plastic battery case for safely releasing the internal pressure thereof.

2. Description of the Prior Art

Due to break-through in material technique, lithium secondary battery, a high capacity power supply (such as LiFePO₄ type lithium secondary battery), has been used for power devices, such as electric bicycle, electric wheelchair, and so on. The power storage and supply capacity of such a high capacity non-aqueous electrolyte type lithium secondary battery are greater than those of a conventional lithium battery. The battery case of the abovementioned lithium secondary battery is usually a metal case made of aluminum. Since the battery case is filled with electrode board and non-aqueous electrolyte, to ensure long term and stable sealing, the open end of the battery case should be sealed with a sealing plate by laser welding.

When the abovementioned lithium secondary battery is overcharged, the interior current value exceeds the normal value. When the battery is misused and results in a short circuit, the non-aqueous electrolyte in the battery case will be fully decomposed and produce a great amount of gas. When gas pressure inside the battery case exceeds the maximum pressure limit, the battery case will be ruptured and gas will be gushed out of the battery case instantly, damaging the powered device the battery and also causing electrolyte contamination.

Therefore, the aluminum sealing plate of the conventional non-aqueous electrolyte lithium secondary battery is usually defined with an air hole sealed with a thin aluminum safety valve. When internal gas pressure of the battery case exceeds a predetermined value, the gas will break through the aluminum valve, releasing the pressure from the battery case.

It is to be noted that the safety valve is located on the surface of the sealing plate. When considering the battery as a whole, the safety valve is located comparatively far away from mid portion of the electrode board. Since the air hole is limited by the size of the sealing plate, the inner diameter of the air hole can not be big. Therefore, it will take a long time for gas to come out of the safety valve. Under normal conditions, when internal pressure of the battery case increases, the mid portion of the battery case will inflate and rupture instantly. The problem is that the safety valve doesn't function as it is supposed to. In other words, a conventional safety valve does not solve the safety issue of a battery case.

Referring to FIG. 1, a safety mechanism for an aluminum rectangular battery case was made and was disclosed in U.S. Pat. No. 6,964,690, in the elongated side surface of the battery case 10 is formed a plurality of cutting grooves 11. Between a groove bottom surface of the cutting groove 11 and an inner surface of the battery case 10 is provided a thin-walled easily-rupturable portion designed to rupture at an instant when an internal pressure of the battery case reaches a predetermined value, thus releasing the gas pressure from the battery case.

For such a safety mechanism design of cutting the cutting grooves in the metal battery case, when the internal pressure of the battery case increases, the easily-rupturable portion will be ruptured. It is to be noted that a great deal of gas pressure impacts the small easily-rupturable portion in a very short time, the resultant ruptured grooves in the battery case will be very large, and as a result, the gas and the non-aqueous electrolyte will be gushed out of the battery case via the ruptured grooves, and the electrode board inside the battery case will be exposed out of the ruptured portion. This is a very large threat to a powered device.

The safety structure of the present invention is such that, when the internal pressure of the battery case increases, the strong impact force caused by the unusual gas pressure increase is buffered and then is released through small slits.

### SUMMARY OF THE INVENTION

The primary objective of the present invention is to provide a plastic integrally formed battery case, in the inner surface of the battery case is formed a plurality of grooves whose open side face the interior of the battery case. When the internal pressure of the battery case is too high, the closest grooves will bulge instantly, and the bulged working portion will not be ruptured right away. When the thickness of the working portion is thinned to zero, a small slit will appear. At this moment, the gas can be released from the slit, thus preventing a great deal of gas from gushing out of the battery case in an instant and contaminating the powered device.

The secondary objective of the present invention is to provide a plastic integrally formed battery case, in the inner surface of the battery case is formed a plurality of grooves whose open side face the interior of the battery case, the open side of the groove is opposite the direction of the gas pressure, thus facilitating the collection of pressure, and making it easier for the thinnest working portion to bulge outward.

### BRIEF DESCRIPTION OF THE DRAWINGS

FIG. 1 is a perspective view of showing a conventional safety structure for an aluminum rectangular battery disclosed in U.S. Pat. No. 6,964,690;

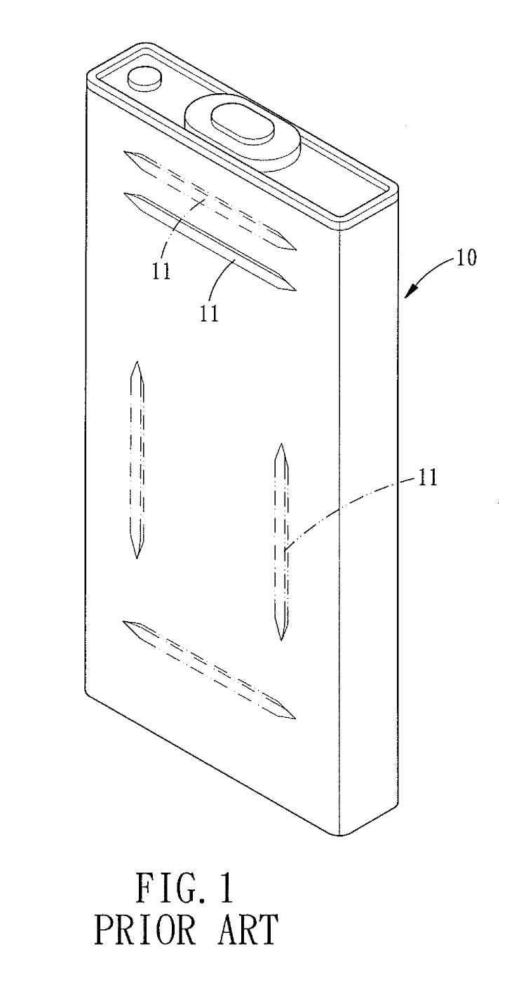

FIG. 2 is an exploded view of a circular plastic battery case and a core assembly in accordance with the present invention;

FIG. 3 is a longitudinal cross sectional view in accordance with the present invention of showing a circular plastic battery case;

FIG. 4 is a transverse cross sectional view in accordance with the present invention of showing a circular plastic battery case;

FIG. 5 is a longitudinal cross sectional view in accordance with the present invention of showing that the working portion in FIG. 4 is being bulged;

FIG. 6 is a longitudinal cross sectional view in accordance with the present invention of showing that the working portion in FIG. 4 is bulged and ruptured to release the gas;

FIG. 7 is an exploded view of a circular plastic battery case with longitudinal and transverse grooves and a core assembly in accordance with the present invention;

FIG. 8 is a longitudinal cross sectional view in accordance with the present invention of showing that the longitudinal and transverse working portions in FIG. 7 is bulged and ruptured to release the gas;

FIG. 9 is an exploded view of a rectangular plastic battery case and a core assembly in accordance with the present invention; and

FIG. 10 is a longitudinal cross sectional view in accordance with the present invention of showing that the working portion in FIG. 9 is bulged and ruptured to release the gas.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

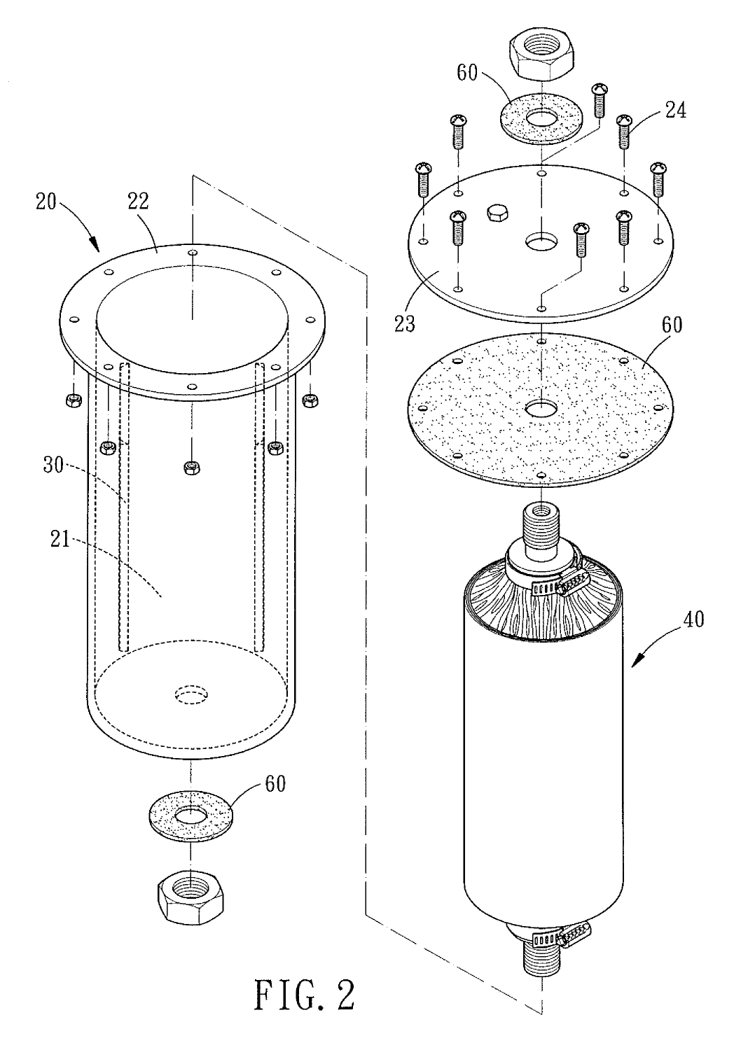

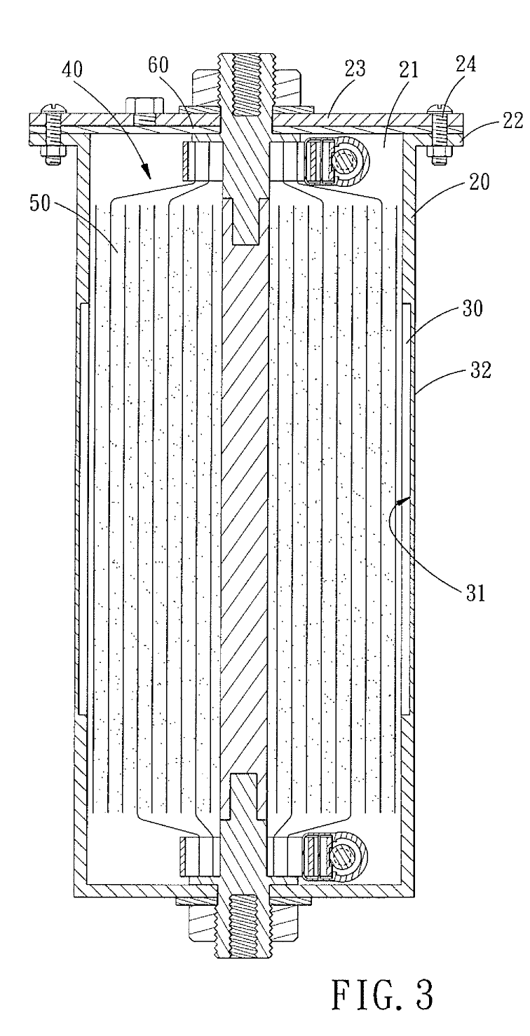

Referring to FIGS. 2, 3 and 4, a safety structure for a plastic battery case in accordance with a preferred embodiment of the present invention comprises at least one groove formed in a battery case, wherein:

The battery case 20 is a circular plastic unitary structure in which is defined a receiving space 21 with an open end for accommodation of a core assembly 40, a leakage-proof washer 60, and non-aqueous electrolyte 50. A connecting flange 22 is formed around the peripheral edge of open end of the receiving space, a cover 23 is fixed to the connecting flange 22 by screws 24 to seal the open end, thus creating an airtight receiving space 21.

In the inner surface of the receiving space 21 of the battery case 20 is formed at least one groove 30 whose open side 31 faces the interior of the battery case 20, and between the bottom of the groove 30 and the outer surface of the battery case 20 is a working portion 32 which is the thinnest portion of the wall of the battery case 20.

When unusual factors (including: overcharge, short circuit of the electrode plate, overload) occur and consequently the non-aqueous electrolyte is decomposed into high pressure gas, the working portion can substantially bulge outward and then become thinner and consequently form a slit to release the gas from the slit.

The battery case of the present invention is made of plastic material, in the inner surface of the battery case is formed at least one groove, and when the internal pressure of the battery case exceeds a predetermined value, the working portion of the groove will bulge outward and become thinner and consequently form a slit for releasing the pressure. And such a pressure-releasing process can prevent the battery from explosion, and ensure that the internal pressure can be released safely. The operation of the embodiment is explained as follows:

Referring to FIGS. 2, 3 and 4 again, the battery case 20 is a unitary structure made of plastic material, in the inner surface of the battery case 20 is formed a plurality of grooves 30, and between the bottom of the grooves 30 and the outer wall of the battery case 20 is a working portion 32 which is the thinnest portion of the wall of the battery case 20. The number of the grooves 30 is based on the size of the battery case 20. For example, a 20 cm diameter circular battery case 20 can be axially formed in its inner surface with four grooves 30, and the grooves 30 are equidistantly arranged.

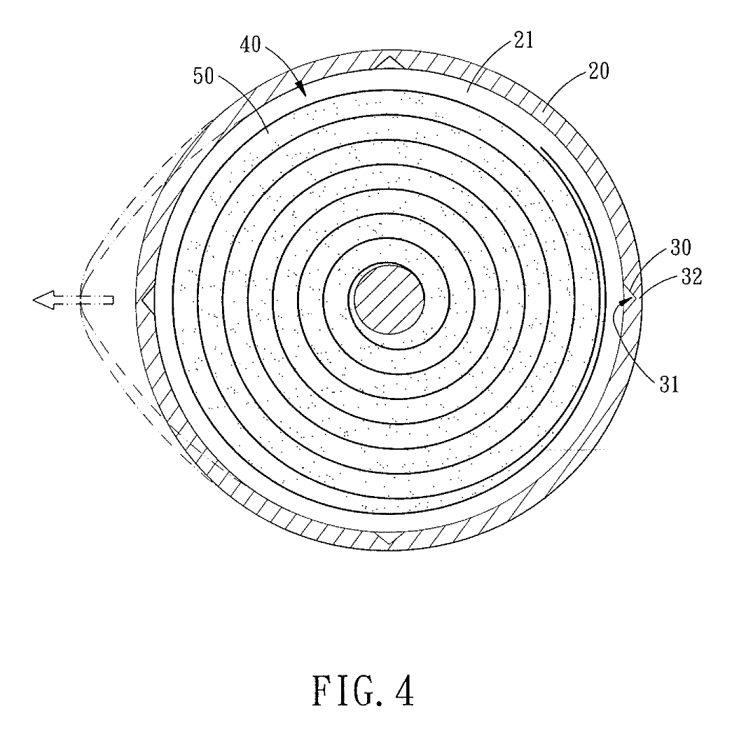

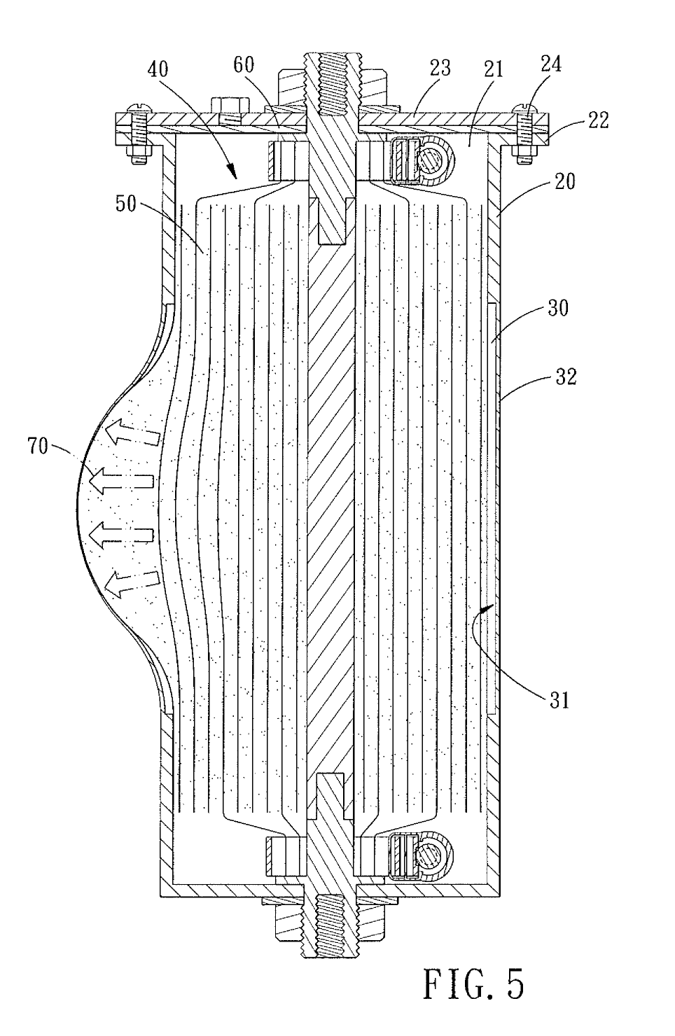

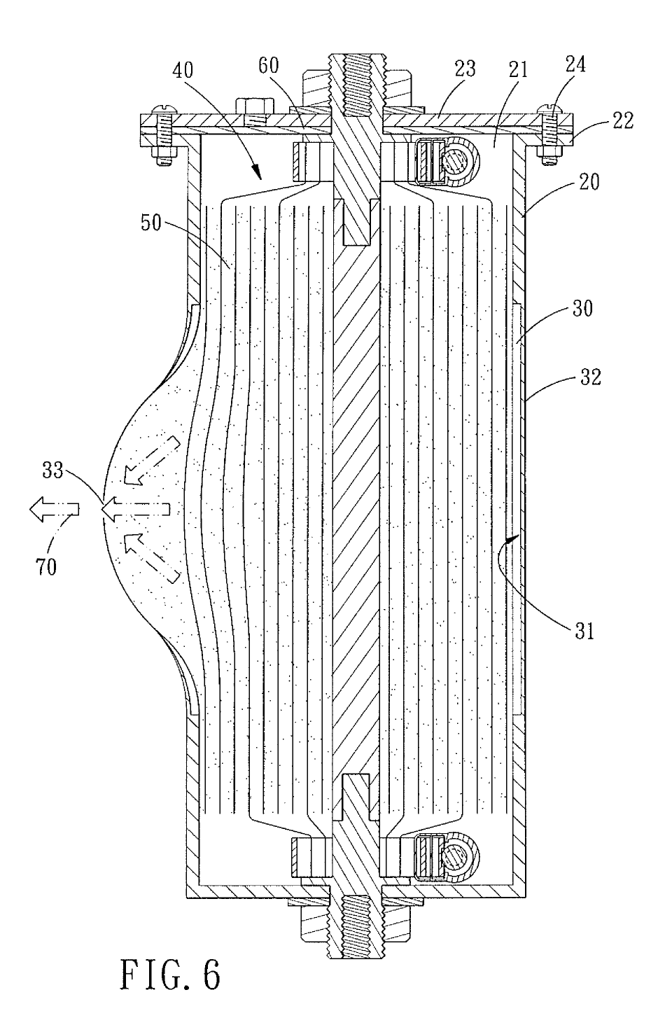

Referring then to FIGS. 4, 5 and 6, when unusual factors occur and consequently the non-aqueous electrolyte is decomposed into high pressure gas 70, the gas pressure will make the battery case 20 bulge outward. It is to be noted that the location where the unusual factors take place may be located at one of the inner sides of the battery case 20 only, and the pressure on this inner side of the battery case 20 is the greatest. The working portion 32 of the grooves 30 located closest to the high pressure point will bulge instantly. The battery case 20 is made of plastic material, and the plastic surface of the battery case 20 has certain flexibility, so that the bulged working portion 32 will not be ruptured right away. The rupture time is prolonged, and then a small slit 33 will appear when the thickness of the working portion 32 is thinned to zero. At this moment, the gas 70 will be released from the battery via the slit 33.

It has to be mentioned that the battery case of the present invention is made of plastic material, and as compared with the conventional metal battery case, the plastic battery case makes it easier for the battery to pass the free-fall test.

It is to be noted that, as shown in FIG. 4, each of the grooves 30 is V-shaped in cross section, and the open side 31 of the grooves 30 faces the interior of the battery case 20. When the unusual gas pressure is applied to the inner surface of the battery case 20, the open side 31 of the grooves 30 is opposite the direction of the gas pressure for facilitating the collection of pressure, and making it easier for the thinnest working portion 32 to bulge toward the radial direction of the battery and consequently form a slit 33. And thus the pressure can be released safely. Therefore, it is very important that the open side 31 of the grooves 30 opens toward the interior of the battery case 20.

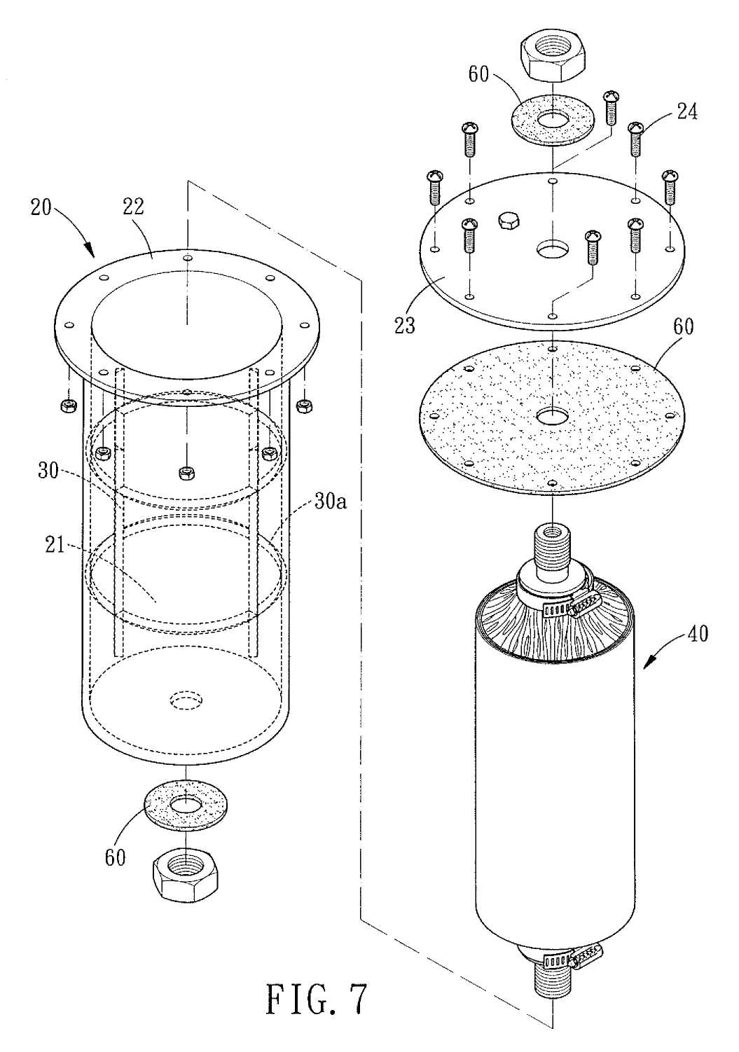

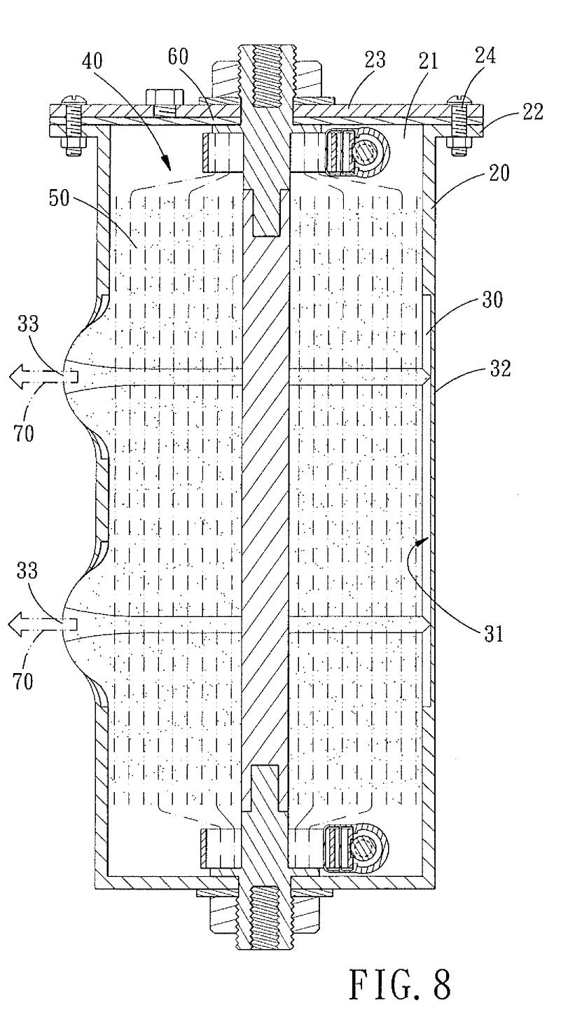

In addition, the location of the grooves 30 is the position where the gas 70 inside the battery case 20 is to be released. With the structural design, the grooves 30 can be arranged at a predetermined position, so that the position where the gas 70 to be released can be anticipated, thus preventing the powered device from being contaminated and damaged. In addition to the longitudinal direction as shown in FIG. 7, the direction in which the grooves 30 are arranged can also be arranged in transverse direction. For example, as shown in FIG. 8, the battery case can be formed with longitudinal grooves 30 and transverse grooves 30a, and it has the same pressure releasing effect.

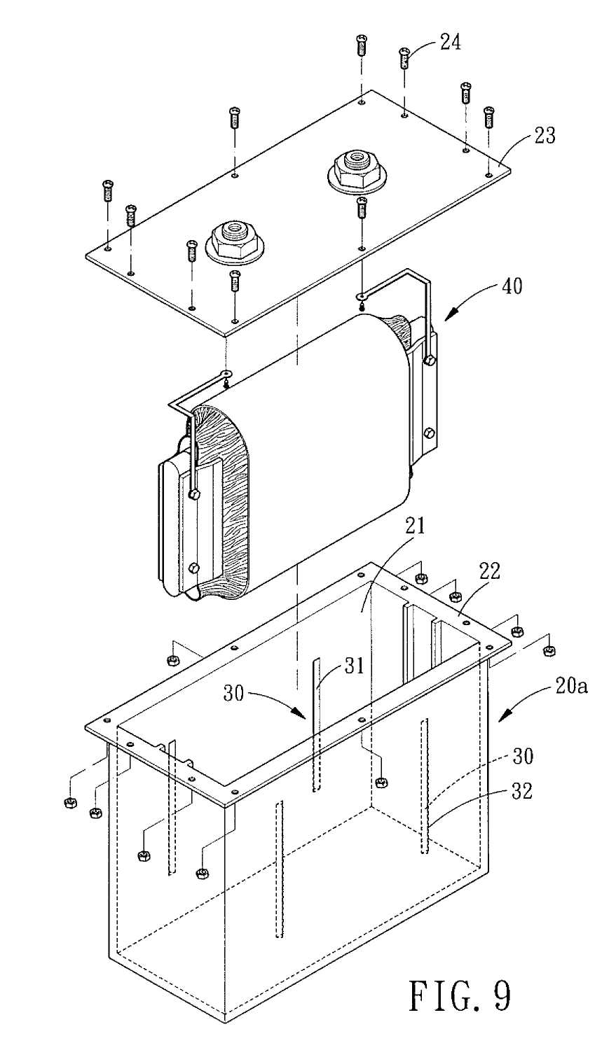

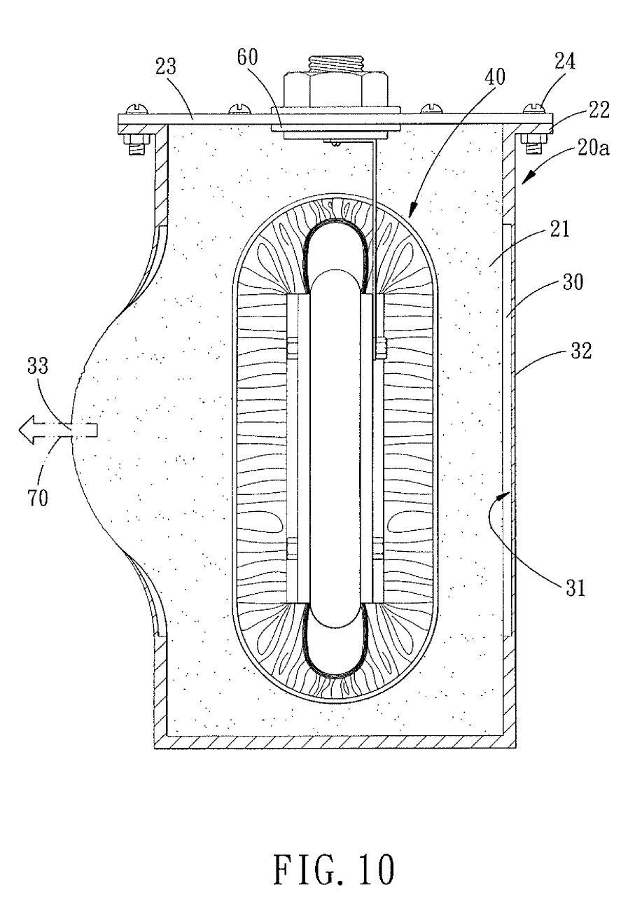

In addition to being used on circular battery case, the safety structure design of the present invention is also suitable for use in a rectangular battery case. With reference to FIG. 9, the grooves 30 and the working portion 32 are formed in the rectangular battery case. And as shown in FIG. 10, which is an illustrative view of showing that the working portion 32 of the rectangular battery 20a is bulged and ruptured.

It can be seen from the above description that the battery case of the present invention is formed in its inner surface thereof with at least one groove, and since the plastic battery case is flexible, when the internal pressure of the battery case exceeds a predetermined value, the working portion of the groove will bulge outward and become thinner and consequently form a slit to release the pressure. In other words, the safety pressure release is achieved by the flexible inflation of the plastic material, so that the strong impact force caused by the unusual gas pressure increase is buffered and then is released.

While we have shown and described various embodiments in accordance with the present invention, it is clear to those skilled in the art that further embodiments may be made without departing from the scope of the present invention.

What is claimed is:

1. A safety structure for a plastic battery case, the battery case being a plastic unitary structure in which being defined a receiving space with an open end for accommodation of electrode plate and electrolyte, the open end being sealed with a cover, thus creating an airtight receiving space; the safety structure is characterized in that:
in an inner surface of the receiving space of the battery case is formed at least one groove whose open side faces an interior of the battery case, and between a bottom of the groove and an outer surface of the battery case is a working portion which is the thinnest portion of the battery case, when internal pressure of the battery case exceeds a predetermined value, the working portion of the groove will bulge outward and become thinner and consequently form a slit to release the pressure.

2. The safety structure for a plastic battery case as claimed in claim 1, wherein the groove is V-shaped in cross section, and the open side of the groove faces the interior of the battery case.

3. The safety structure for a plastic battery case as claimed in claim 1, wherein the groove is arranged in a longitudinal direction.

4. The safety structure for a plastic battery case as claimed in claim 1, wherein the groove is arranged both in longitudinal and transverse directions.
